(19) United States
(12) Patent Application Publication
(10) Pub. No.: US 2013/0139593 A1
(43) Pub. Date: Jun. 6, 2013

(54) INERTIAL SENSOR WITH STRESS ISOLATION STRUCTURE

(71) Applicants: Hsieh-Shen Hsieh, Hsinchu City (TW); Wei-leun Fang, Hsinchu City (TW)

(72) Inventors: Hsieh-Shen Hsieh, Hsinchu City (TW); Wei-leun Fang, Hsinchu City (TW)

(21) Appl. No.: 13/480,884

(22) Filed: May 25, 2012

(30) Foreign Application Priority Data
Dec. 1, 2011 (TW) 100144101

(51) Int. Cl. G01P 15/00

(52) U.S. Cl. 73/514.01

(57) ABSTRACT

An inertial sensor with stress isolation structure includes a substrate, a suspension bridge, a guard ring and an electromechanical conversion mechanism. The substrate has a housing trough and an annular wall surrounding the housing trough. The suspension bridge is located in the housing trough and connected to the annular wall. The guard ring is connected to the suspension bridge and suspended in the housing trough. The suspension bridge is located between the substrate and guard ring. The electromechanical conversion mechanism is connected to and surrounded by the guard ring. Through the guard ring, interferences of applied forces to the electromechanical conversion mechanism can be reduced, precision of the inertial sensor can be improved, and performance impact caused by succeeding element package process can also be reduced. Thus package, test and calibration processes can be simplified to lower production cost.

### FIELD OF THE INVENTION

The present invention relates to an inertial sensor and particularly to an inertial sensor with stress isolation structure.

### BACKGROUND OF THE INVENTION

Acceleration sensors in the past mostly were used on vehicles to activate a safety airbag via acceleration in the event of impact. The acceleration sensor adopted on the vehicles generally aims to detect the acceleration in one direction of X-direction or Y-direction. Due to the measured acceleration is great, the acceleration sensor must be constructed sturdily. However, with constant advances of technology, consumer electronic products have to follow the trend of thin and light, and users generally prefer to have a built-in acceleration sensor. To comply with these requirements, nowadays the acceleration sensor generally is made by adopting micro-electromechanical fabrication process and becomes a smaller size, and sensitivity also improves.

The conventional acceleration sensor made via the micro-electromechanical fabrication process, such as U.S. publication No. 2010/0116057 entitled “MEMS SENSOR AND METHOD OF MANUFACTURING THE SAME” discloses an inertial sensor which comprises a frame, a weight member and four transverse beams. The weight member is located in and surrounded by the frame, and includes a center member and four peripheral members connecting to the center member. The four transverse beams are connected respectively to four inner sides of the frame, and also connected to the center member. Each transverse beam has a piezoresistive sensor located thereon. When the inertial sensor receives an applied force, the weight member swings to result in deformation of the transverse beams, thus the impedance of the piezoresistive sensor changes and the acceleration can be detected.

However, the aforesaid conventional inertial sensor is easily interfered by applied forces induced by the environmental disturbances. That will lead to the unwanted spring deflection, thus accuracy decreases. To remedy such a problem, a special package approach is selected during fabrication of the inertial sensor, such as ceramic package or plastic cavity package. However, production cost of such special package approach is higher.

### SUMMARY OF THE INVENTION

The primary object of the present invention is to solve the problem of the conventional inertial sensor that is easily interfered by applied forces induced by the environmental disturbances. Another object of the present invention is to alleviate performance impact caused by succeeding element package process.

To achieve the foregoing objects, the present invention provides an inertial sensor with stress isolation structure. It includes a substrate, a suspension bridge, a guard ring and an electromechanical conversion mechanism. The substrate has a housing trough and an annular wall surrounding the housing trough. The suspension bridge is located in the housing trough and connected to the annular wall, and interposed between the substrate and guard ring. The guard ring is connected to the suspension bridge and suspended in the housing trough. The electromechanical conversion mechanism is connected to and surrounded by the guard ring.

Through the guard ring, interferences of the applied forces to the electromechanical conversion mechanism can be reduced. Not only detection accuracy of the electromechanical conversion mechanism improves, performance impact caused by succeeding element package process also is lower, and production cost decreases as well.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1A is a front perspective view of a first embodiment of the invention, partly cut away.

FIG. 1B is a rear perspective view of the first embodiment of the invention, partly cut away.

FIG. 2A is a schematic view of the first embodiment of the invention, showing detection in the horizontal direction.

FIG. 2B is a schematic view of the first embodiment of the invention, showing detection in the vertical direction

FIG. 3 is a fragmentary schematic view of a second embodiment of the invention.

FIGS. 4A through 4D are schematic views of the suspension bridge structure of the second embodiment.

FIG. 5A is a chart showing comparisons between the invention with a conventional inertial sensor in terms of temperature interference.

FIG. 5B is a chart showing comparisons between the invention with a conventional inertial sensor in terms of applied force interference.

### DETAILED DESCRIPTION OF THE PREFERRED EMBODIMENTS

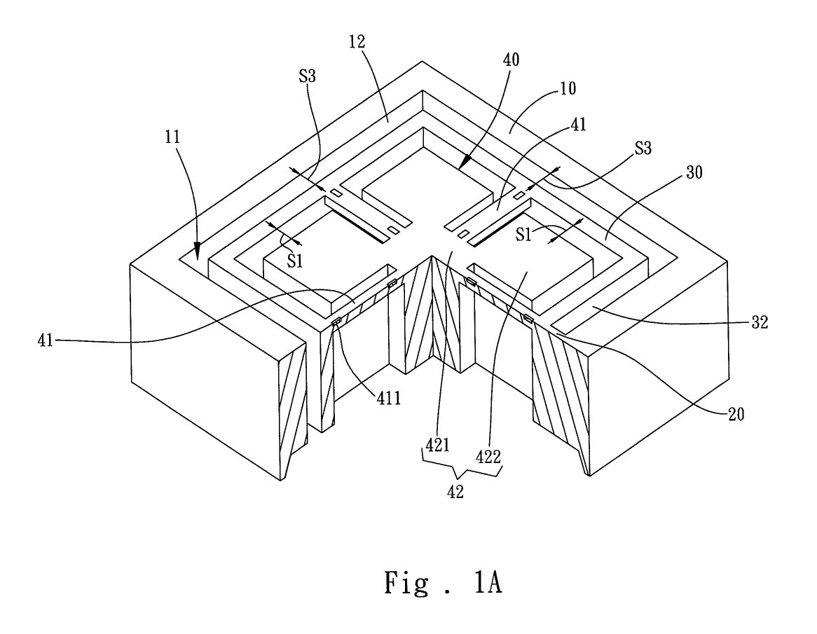

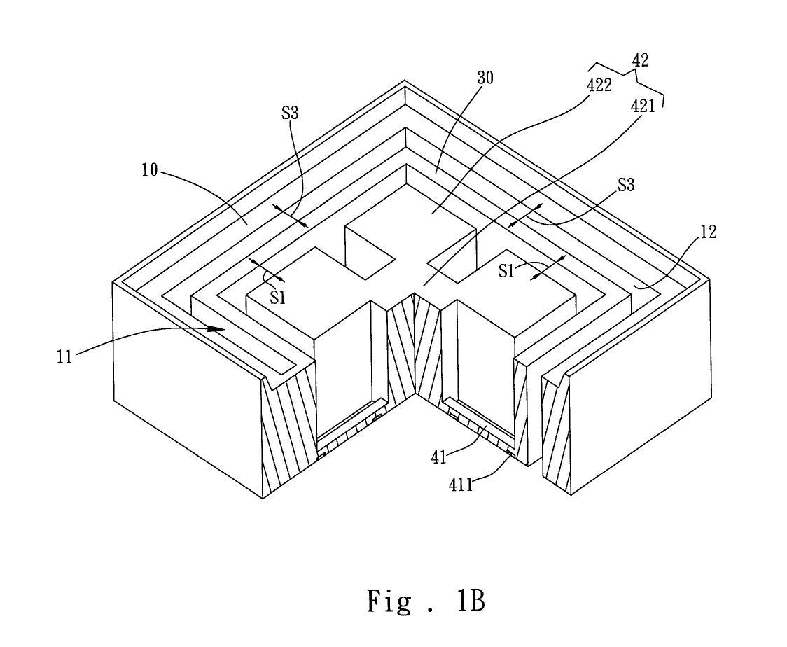

Please refer to FIGS. 1A and 1B for a first embodiment of the invention. The inertial sensor with stress isolation structure according to the invention includes a substrate 10, a suspension bridge 20, a guard ring 30 and an electromechanical conversion mechanism 40. The substrate 10 has a housing trough 11 and an annular wall 12 surrounding the housing trough 12. The suspension bridge 20 is located in the housing trough 12 and connected to the annular wall 12. The guard ring 30 has one connection side 32 connecting to the suspension bridge 20 to be suspended in the housing trough 11. The suspension bridge 20 is located between the substrate 10 and guard ring 30. The guard ring 30 and annular wall 12 are spaced from each other via a buffer gap S3. The electromechanical conversion mechanism 40 is connected to and surrounded by the guard ring 30, and can be a mechanical capacitance conversion mechanism, a piezoelectric conversion mechanism or a piezoresistive conversion mechanism.

In the first embodiment, the electromechanical conversion mechanism 40 can be a piezoresistive conversion mechanism or a piezoelectric conversion mechanism, and includes at least one suspension arm 41 and an inertial member 42. The suspension arm 41 is connected to the guard ring 30. The inertial member 42 is connected to the suspension arm 41, and the suspension arm 41 is resilient and is located between the guard ring 30 and inertial member 42. Moreover, the inertial member 42 and guard ring 30 are spaced from each other via a movement interval S1 for movements of the inertial member 42. In this embodiment, the inertial member 42 includes a center member 421 and four weight members 422 connecting to the center member 421. The suspension arm 41 includes four sets bridging the center member 421 and guard ring 30, and each being interposed between two neighboring weight members 422. Each suspension arm 41 further may have a piezoresistive element 411 or piezoelectric element located thereon. When the suspension arm 41 is subject to an applied force and deforms, the piezoresistive element 411 detects alterations of the stress of the suspension arm 41 and generates corresponding resistance alterations. Or the piezoelectric element detects the alterations of the stress of the suspension arm 41 and generates corresponding electric charge alterations, and obtains electric signal output of elements corresponding to the inertia action (such as acceleration or angular speed) through a selected circuit. Hence the electromechanical conversion mechanism 40 becomes the piezoresistive conversion mechanism to detect the stress alterations of the suspension arm 41 and generate corresponding impedance alterations, or the piezoelectric conversion mechanism to generate corresponding electric charge alterations. In this embodiment the piezoresistive element 411 is adopted as an example.

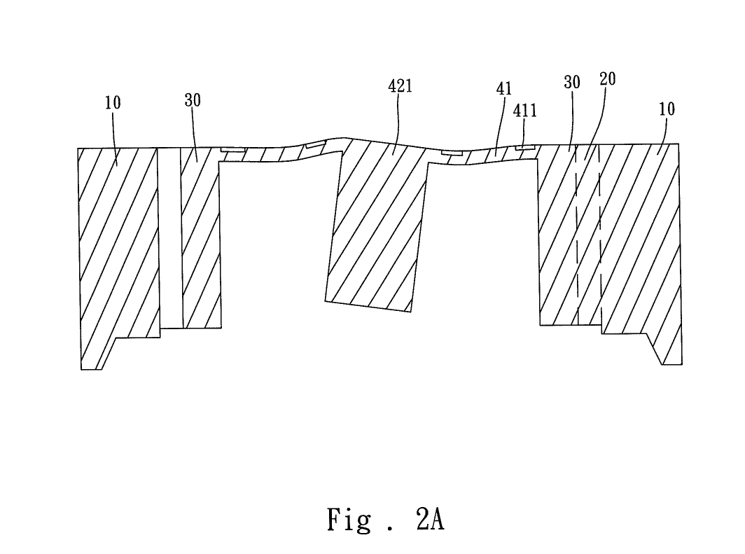

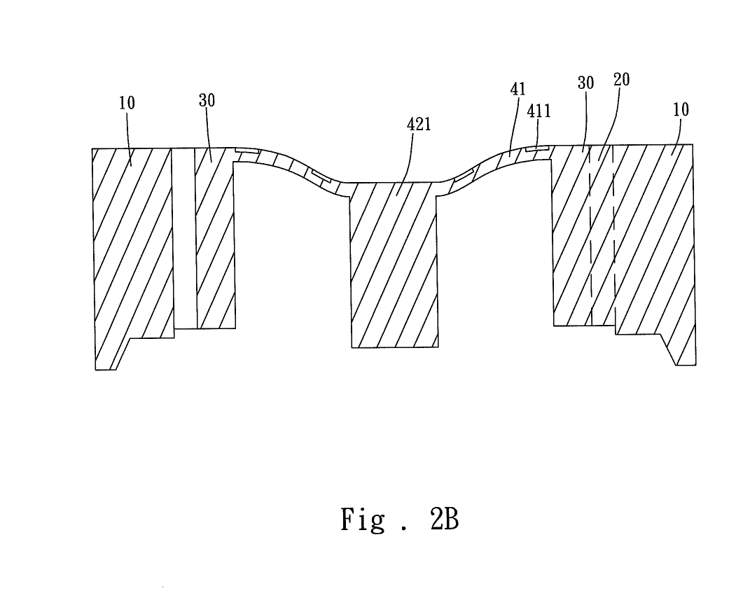

Please refer to FIG. 2A for the first embodiment in use to perform detection in the horizontal direction, and FIG. 2B for the first embodiment in use to perform detection in the vertical direction. The inertial sensor of the invention can detect three axes in a three-dimensional space. Referring to FIG. 2A, when the inertial sensor is subject to an inertia force in the horizontal direction, such as a horizontal force on the X-direction or Y-direction, the inertial sensor generates a transverse movement which destroys the horizontal balance of the inertial member 42. The weight members 422 tow the center member 421 to sway horizontally, and consequentially tow the suspension arm 41 bridging the center member 421 and guard ring 30, and the suspension arm 41 deforms horizontally and results in a stress alteration. Then the piezoresistive element 411 located on the suspension arm 41 detects the stress alterations of the suspension arm 41 and generates corresponding impedance alterations, thereby can detect the inertia forces on the X-direction and Y-direction. Referring to FIG. 2B, when the inertial sensor is subject to an inertia force in the vertical direction, such as a vertical force on the Z-direction, the inertial sensor generates a vertical movement which destroys the vertical balance of the inertial member 42. The weight members 422 drive the center member 421 to swing vertically, and then the suspension arm 41 bridging the center member 421 and guard ring 30 is thus pulled and deformed vertically to result in stress alterations of the suspension arm 41. Then the piezoresistive element 411 located on the suspension arm 41 detects the stress alterations of the suspension arm 41 and generates corresponding impedance alterations, thereby can detect the inertia force on the Z-direction.

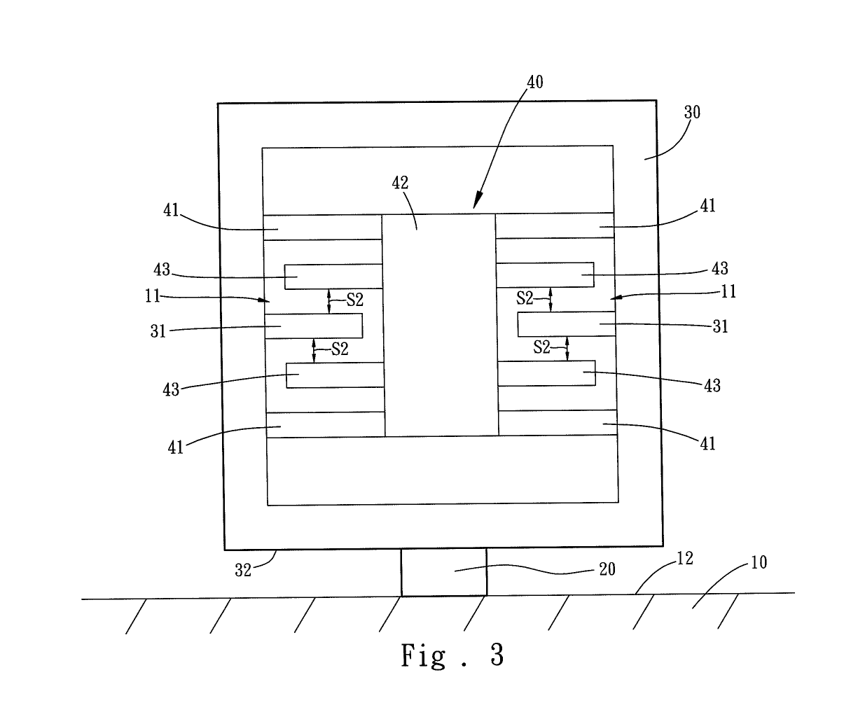

Please refer to FIG. 3 for a fragmentary view of a second embodiment of the invention. In this embodiment, the electromechanical conversion mechanism 40 is a mechanical capacitance conversion mechanism, and includes at least one suspension arm 41, an inertial member 42 and at least one movable fork 43. The suspension arm 41 bridges the guard ring 30 and inertial member 42. The inertial member 42 is suspended in the housing trough 11 via the suspension arm 41. The movable fork 43 is connected to the inertial member 42. The guard ring 30 has at least one fixed fork 31 spaced from the movable fork 43 via a changeable interval S2. Through the movable fork 43, fixed fork 31 and changeable interval S2, a capacitor mechanism is formed. The suspension arm 41 includes four sets bridging the inertial member 42 and guard ring 30 to allow the inertial member 42 to suspend in the housing trough 11 with balance. The movable fork 43 includes four sets. The fixed fork 31 includes two sets located at two opposite sides in the guard ring 30 and between two neighboring movable forks 43. However, the number of the fixed fork 31, the suspension arm 41 and the movable fork 43 is only an exemplification but not the limitation to the present invention. It is to be noted that when the inertial sensor is subject to an inertia force, the inertial member 42 moves and drives the movable forks 43, thereby the changeable interval S2 between the movable forks 43 and fixed forks 31 changes, thus the capacitance of the capacitor mechanism also changes. Hence by detecting the capacitance change the movement can be detected.

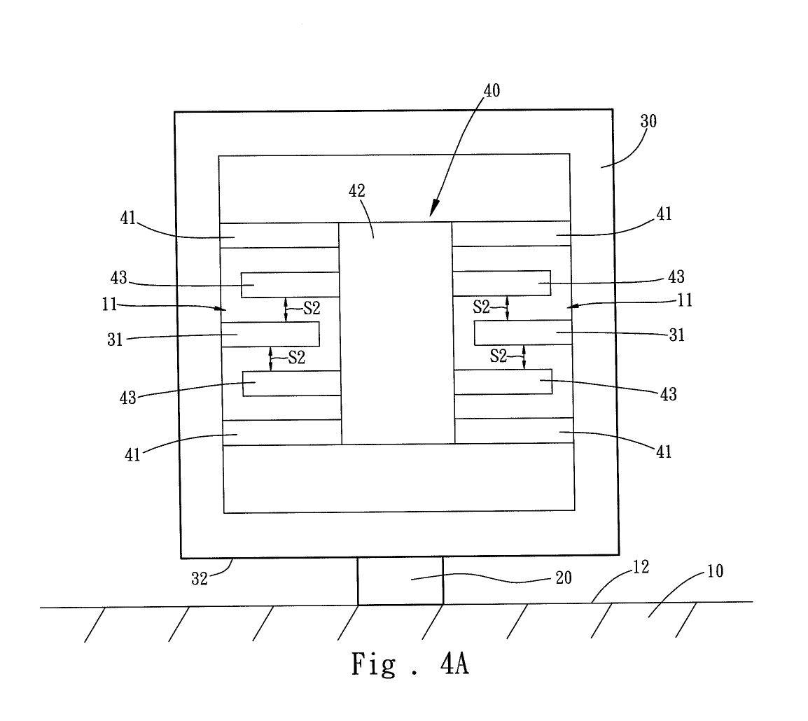

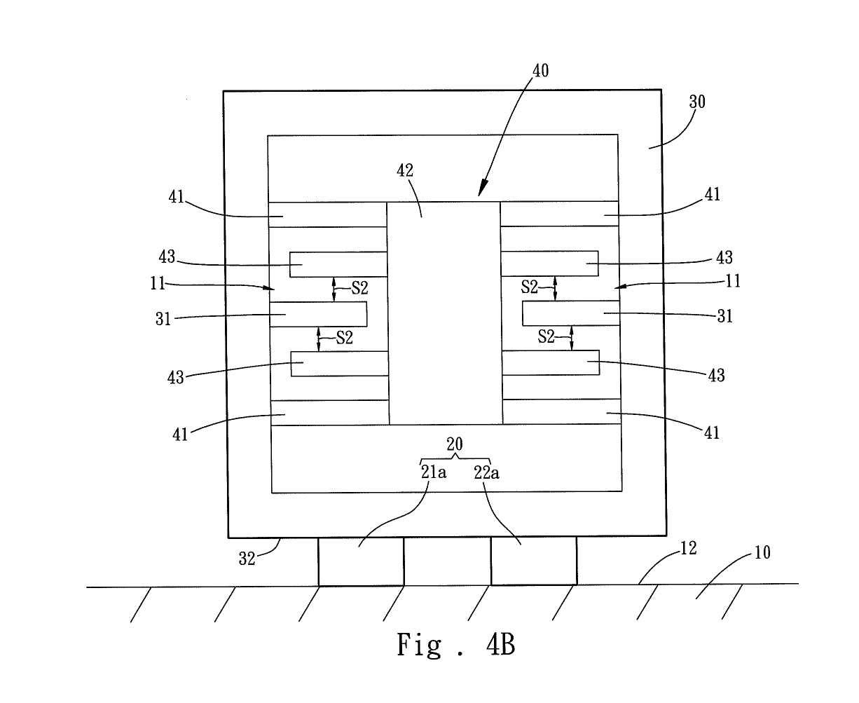

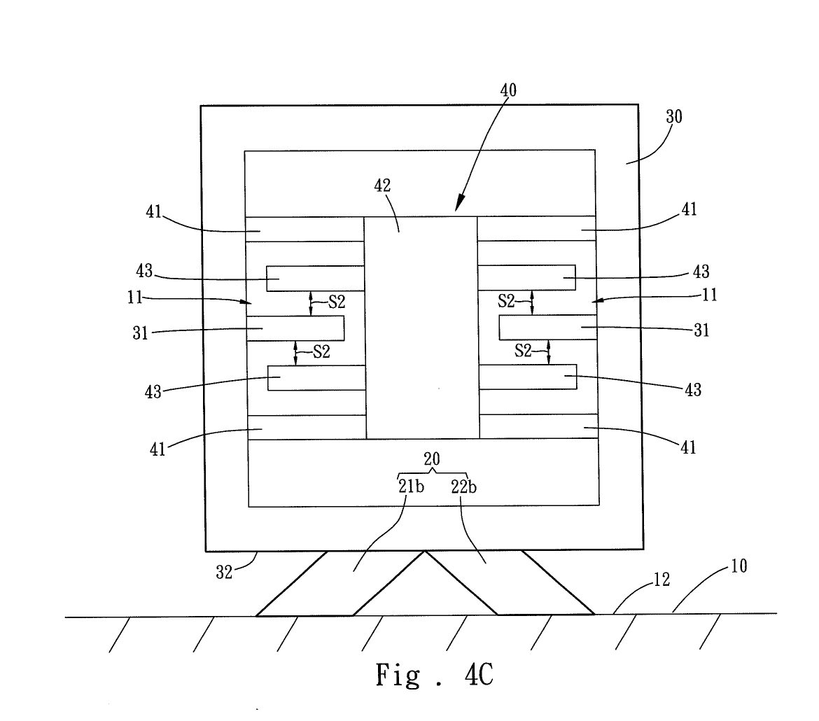

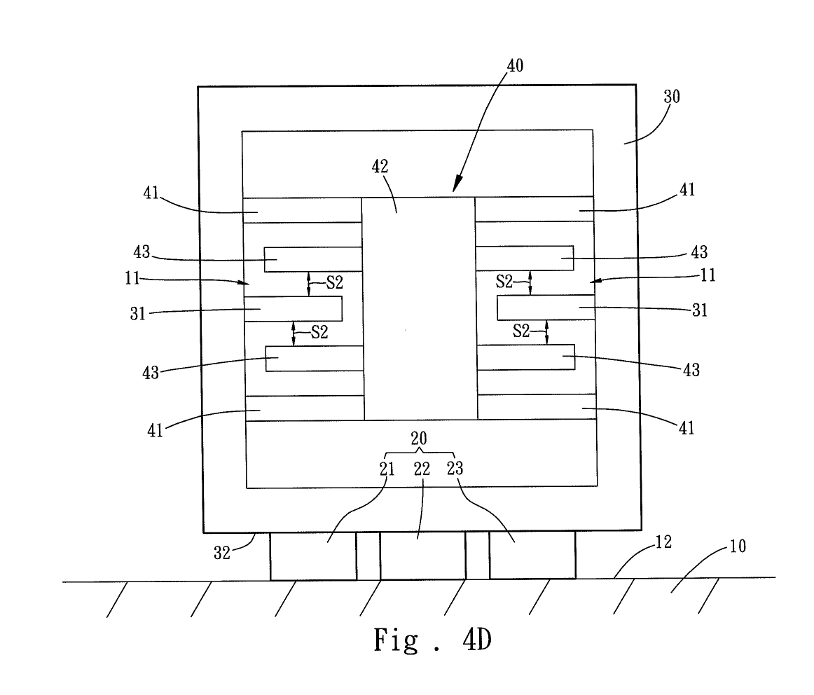

Please refer to FIGS. 4A through 4D for the suspension bridge structure of the second embodiment of the invention. It is to be noted that the suspension bridge 20 is connected to one connection side 32 of the guard ring 30, and the connection can be formed in four types as discussed below, but these are not the limitation. In FIG. 4A, the suspension bridge 20 is a single member with two ends bridging the guard ring 30 and annular wall 12. In FIG. 4B, the suspension bridge 20 includes a first branch 21a and a second branch 22a with two ends bridging respectively the guard ring 30 and annular wall 12; and the two branches 21a and 22a are positioned in a juxtaposed manner. In FIG. 4C, the suspension bridge 20 includes a first branch 21b and a second branch 22b with two ends bridging respectively the guard ring 30 and annular wall 12; and the two branches 21b and 22b are positioned non-parallel. In FIG. 4D, the suspension bridge 20 includes a first branch 21, a second branch 22 and a third branch 23 with two ends bridging respectively the guard ring 30 and annular wall 12; and the first, second and third branches 21, 22 and 23 are positioned in a juxtaposed manner. It is also to be noted that the aforesaid suspension bridge 20 is not limited to the second embodiment, and can also be adopted in the first embodiment or in other electromechanical conversion mechanisms 40 connected to the guard ring 30, and also can include more branches such as a fourth branch, a fifth branch and the like.

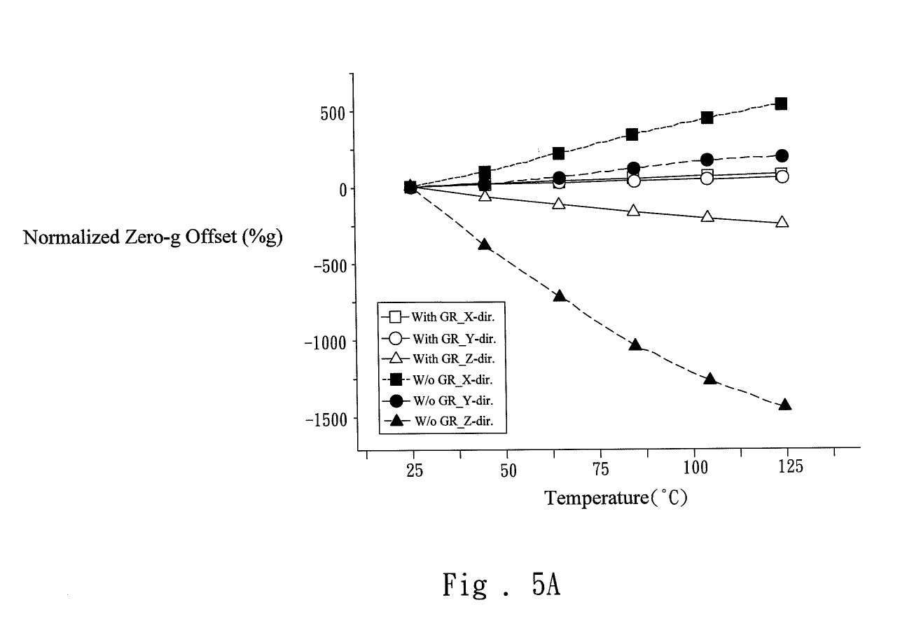

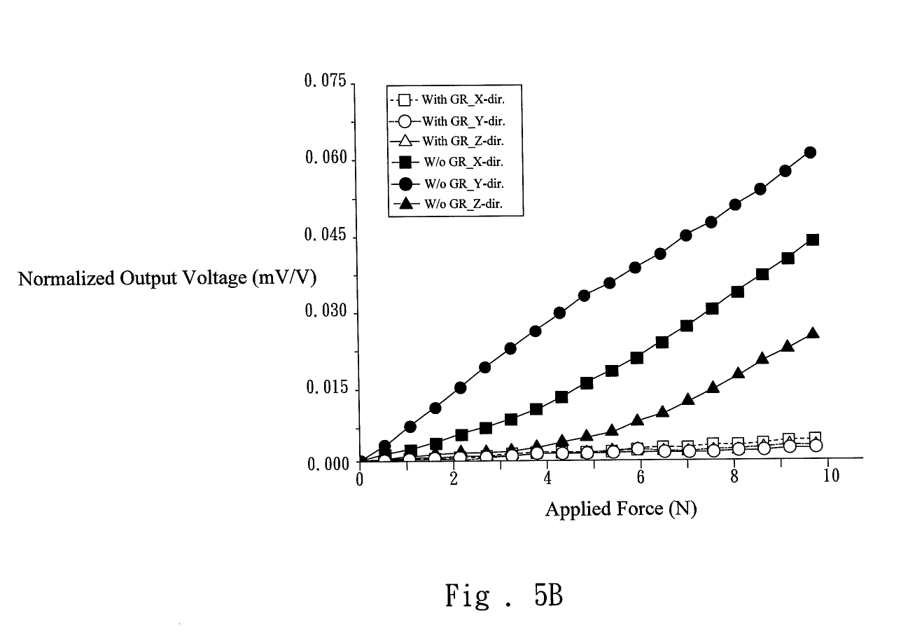

Please refer to FIGS. 5A and 5B for comparisons between the invention and the conventional inertial sensor in terms of temperature and applied force interfaces respectively. FIG. 5A shows that the stress interface of the inertial sensor equipped with the guard ring 30 caused by temperature on the X-direction, Y-direction and Z-direction is about one level lower than that of the inertial sensor without the guard ring 30. FIG. 5B shows that the interface of the inertial sensor equipped with the guard ring 30 caused by applied force on the X-direction, Y-direction and Z-direction is reduced to between ⅛ and 1/26 than that of the inertial sensor without the guard ring 30.

As a conclusion, through the guard ring provided by the invention, impact of environmental factors to the electromechanical conversion mechanism can be reduced, and the stress interference caused by temperature can be lowered about one level, while the interference caused by applied forces can be reduced to between ⅛ and 1/26, therefore greatly improves the detection precision of the electromechanical conversion mechanism, and also reduces performance impact caused by the succeeding element package process. Thus package, test and calibration processes can be simplified to lower production cost. It provides significant improvements over the conventional techniques.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. An inertial sensor with stress isolation structure, comprising:
a substrate including a housing trough and an annular wall surrounding the housing trough;
a suspension bridge held in the housing trough and connected to the annular wall;
a guard ring connected to the suspension bridge and suspended in the housing trough, the suspension bridge being located between the substrate and the guard ring; and
an electromechanical conversion mechanism connected to and surrounded by the guard ring.

2. The inertial sensor of claim 1, wherein the electromechanical conversion mechanism is selected from the group consisting of a mechanical capacitance conversion mechanism, a piezoelectric conversion mechanism and a piezoresistive conversion mechanism.

3. The inertial sensor of claim 1, wherein the electromechanical conversion mechanism includes at least one suspension arm connected to the guard ring and an inertial member connected to the suspension arm, the suspension arm being located between the guard ring and the inertial member, the inertial member being suspended in the housing trough and surrounded by the guard ring.

4. The inertial sensor of claim 3, wherein the inertial member includes a center member and four weight members connected to the center member, the suspension arm including four sets connected respectively to the center member and the guard ring and interposed between two neighboring weight members.

5. The inertial sensor of claim 3, wherein the guard ring and the inertial member are spaced from each other via a movement interval for movements of the inertial member.

6. The inertial sensor of claim 3, wherein the suspension arm includes a piezoresistive element.

7. The inertial sensor of claim 3, wherein the suspension arm includes a piezoelectric element.

8. The inertial sensor of claim 1, wherein the electromechanical conversion mechanism includes at least one suspension arm connected to the guard ring, an inertial member connected to the suspension arm and at least one movable fork connected to the inertial member, the suspension arm being located between the guard ring and the inertial member, the inertial member being suspended in the housing trough, the guard ring including at least one fixed fork spaced from the movable fork via a changeable interval.

9. The inertial sensor of claim 8, wherein the guard ring and the inertial member are spaced from each other via a movement interval for movements of the inertial member.

10. The inertial sensor of claim 1, wherein the guard ring and the annular wall are spaced from each other via a buffer gap.

11. The inertial sensor of claim 1, wherein the guard ring includes one connection side connecting to the suspension bridge.

12. The inertial sensor of claim 1, wherein the suspension bridge includes a first branch and a second branch.
